(19) United States
(12) Patent Application Publication
(10) Pub. No.: US 2009/0095555 A1
(43) Pub. Date: Apr. 16, 2009

(54) Rollover protection system for motor vehicles with a sensor-controlled actively deployable rollover body

(75) Inventors: Michael Nass, Bergneustadt (DE); Gurkan Beki, Engelskirchen (DE)

Correspondence Address: FLASTER/GREENBERG P.C.;8 PENN CENTER, 1628 JOHN F. KENNEDY BLVD., 15TH FLOOR, PHILADELPHIA, PA, 19103, US

(73) Assignee: Automotive Group ISE Innomotive Systems Europe GmbH, Bergneustadt (DE)

(21) Appl. No.: 12/079,037

(22) Filed: Mar. 24, 2008

(30) Foreign Application Priority Data
Mar. 23, 2007 (DE) 10 2007 013 954.5

(51) Int. Cl. B60K 28/14

(52) U.S. Cl. 180/282

(57) ABSTRACT

The invention is based on a known rollover protection system for motor vehicles having
a holder affixed to the vehicle,
a rollover body,
a drive for deploying rollover body from a resting position to a protective position,
a device for holding rollover body in the resting position,
a sensor-controlled actuator for triggering holding device and
a blocking bolt arrangement with two locking bolts under spring tension that engage in locking holes of rollover body when rollover body is deployed in the protective position.
   It is proposed that blocking bolt arrangement has a housing affixed to the vehicle and open at the end, in which locking bolts are positioned at the end with a single pressure spring positioned in between, by means of which locking bolts can be driven into locking holes.

### BACKGROUND OF THE INVENTION

1. Field of the Invention

The invention relates to a rollover system for motor vehicles according to the preamble of Claim 1.

2. Description of Related Art

Such rollover protection systems are for protecting passengers in motor vehicles without a protective roof, typically in convertibles or roadsters, so that the vehicle rolls over the deployed rollover body, which creates a survival area for the passengers in a rollover.

It is known to provide a roll bar that extends the entire width of the motor vehicle and is designed as part of the body. In this solution, the increased air resistance and vehicle noise generated is perceived as disadvantageous, apart from the impairment of the vehicle's appearance.

It is also known to assign each vehicle seat a non-height-adjustable roll bar permanently installed in the passenger compartment, i.e. a rigid, U-shaped roll bar. This solution is typically used for roadsters to underscore the sporty appearance.

Widespread in convertibles are design solutions where the rollover body is normally retracted and, in case of a hazard, i.e. in case of an imminent rollover, the rollover body quickly deploys into a protective position to prevent the passengers from being crushed by the rolling vehicle.

These so-called “active” rollover protection systems typically have a U-shaped roll bar guided in a guide body permanently attached to the vehicle or a rollover body formed out of a shaped body, and the guide body is affixed in a cassette housing that has side parts and a floor part. This roll bar or rollover body is normally held by a holding device in a lower, resting position under spring tension from at least one drive pressure spring, and in a rollover, the roll bar can be moved into an upper, protective position in response to a sensor by means of the spring force of the drive pressure spring when the holding device releases, and a locking device, the retraction lock, having engaging teeth prevents the roll bar from being pressed back inside. Each motor vehicle seat is typically assigned one cassette. Such a cassette construction of an active rollover protection system with a U-shaped roll bar is disclosed, for example, in DE 100 40 649 C1.

In addition to cassette designs, active rollover protection systems are also known that use a rear wall principle and have a rear wall assembly as described, for example, in DE 103 44 446 B3. This principle has a frame construction, positioned between the rear passenger compartment and the trunk, consisting on the one hand of a shaped cross member permanently affixed to the body and extending across the inner width of the vehicle that has guiding means for two adjacent, U-shaped roll bars, and consisting on the other hand of shaped member elements extending vertically downward with a floor part for receiving the usual components of the extendable rollover protection system such as the trigger magnet for the sensor-controlled triggering of the extension movement of the roll bars, and the drive pressure springs.

Both the cassette designs and cross member designs have been introduced to the market and are used in many embodiments adapted to the respective vehicle type.

In all these active rollover protection systems, in which the invention too can be used, it is necessary to provide a locking device activatable in case of hazard, the retraction lock, that in the deployed state of the rollover body prevents it from being pushed back into the cassette or into the rear wall assembly, with loss of the survival area, due to the forces generated in a rollover. This locking device therefore performs an essential safety function.

Numerous constructions for this locking device have become known in the prior art. They are predominantly based on the engaging interaction of two mutually complementary tooth elements. Thus the cited DE 100 40 649 C1 discloses a locking device consisting, first, of a latch arbor which is fastened to a traverse that links both arm ends of the corresponding U-shaped roll bar and that moves out with it, and second, of a detent pawl that is articulated in a pivoting manner in the massive guide block affixed to the vehicle that guides the bar arms, in such a way that it can be caused to lockingly engage with the latch arbor. Solutions are also known in the prior art in which the two locking components are positioned in the opposite manner, i.e. with the latch arbor on the guide block affixed to the vehicle and the detent pawl on the traverse that moves out with the rollover body. Solutions with toothed strips are also known in the prior art.

In these known solutions, the locking device is stressed by the rollover forces largely on one side, i.e. asymmetrically, aside from the necessary component and assembly expense.

Another type of locking mechanism is achieved by the extendable roll bar of DE 39 05 470 A1, in which the arresting and blocking mechanism are functionally combined and consists of one at least two-armed lever for each arm of the roll bar. One arm of the lever is held in the blocking position via an arm of the trigger mechanism under tension from a tension spring, and the other arm of the lever is brought into the locking position by the tension spring in case of activation. While this locking mechanism is symmetrical on both arms of the roll bar, it is nonetheless relatively complex.

DE 39 30 171 A1 and DE 103 53 867 B3 disclose extendable rollover bodies according to the preamble of Claim 1, in which blocking members or locking bolts under spring tension engage in lock holes when the rollover body has been extended to the protective position. There are two or even four locking elements, each provided with its own pretension springs. These locking mechanisms from the prior art are also viewed as too complex.

The enormous cost pressure in the automobile industry requires ever lower cost solutions from supplier companies. So it is too with respect to rollover protection systems.

Therefore the underlying task of the invention is to create a rollover protection system with a very simple, low-cost locking device preventing the retraction of the rollover body after deployment due to an accident, which nonetheless ensures very secure locking of the rollover body.

### BRIEF SUMMARY OF THE INVENTION

The solution of this task is accomplished by a rollover protection system for motor vehicles having

a holder affixed to the vehicle,
a rollover body,
a drive for deploying the rollover body from a resting position to a protective position,
a device for holding the rollover body in the resting position,
a sensor-controlled actuator for triggering the holding device and
a blocking bolt arrangement with two locking bolts under spring tension that engage in locking holes of the rollover body when the rollover body is deployed in the protective position,
   by means of the fact that the blocking bolt arrangement has a housing affixed to the vehicle and open at the side end, in which the locking bolts are positioned at the end with a single pressure spring positioned in between, by means of which the locking bolts can be driven into the locking holes.

Therefore, in the locking mechanism according to the invention, only one simple linearly active blocking bolt arrangement is required for the locking action, which reduces the component and assembly expense—and thus the cost as well. In addition, in the case of a U-shaped roll bar, the traverse with the latch arbor can be dispensed with. The holder of the rollover body affixed to the vehicle, the so-called typically massively designed guide block, can also be designed much more simply, since its only task now essentially is to guide the rollover body. Thus it would be conceivable in the case of U-shaped roll bars to construct the guide block for the bar arms using a simple shaped piece, e.g. a C-profile, tubes with welded-on tubes and flanges. The forces arising in the locking device during a rollover are absorbed largely directly into the rollover body, e.g. into the bar arms, by means of a targeted force conveyance.

In a special further embodiment of the invention, the blocking bolt arrangement, which extends across a specified width, is positioned on the fixed part of the rollover protection system and has linearly emerging locking bolts on both front faces that, in case of locking, engage in the walls of the rollover body in a bilaterally blocking manner; in this way the locking occurs directly on the rollover body, particularly on its two bar arms in the case of a U-shaped roll bar. Because of the length of the blocking bolt arrangement extending across a specified width of the rollover body and because of the spaced simultaneous engagement of the locking bolts (which can also be described as locking pegs) with the rollover body, i.e. with its bar arms in the case of a U-shaped roll bar or with corresponding profile segments in the case of a rollover body, the locking device is stressed relatively evenly by the centrally impacting rollover forces.

In the case of U-shaped roll bar system with arm tubes of different lengths, this can be designed in such a way that a spring drive with only one helical spring in the longer arm tube is provided as a drive for deploying the roll bar, with the spring being guided by a spring guide rod. Therefore, the shorter design of the arm tube provides space for a loading area.

Further embodiments of the invention are cited in subclaims 2 to 11 and also result from the description of the figures.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. The invention will be further explained with reference to an exemplary embodiment of the inventive locking device shown in the drawings. For the purpose of illustrating the invention, there is shown in the drawings embodiments which are presently preferred. It should be understood, however, that the invention is not limited to the precise arrangements and instrumentalities shown. In the drawings:

FIG. 1 shows an isometric view of a rollover protection system with a U-shaped roll bar stored in the resting position, which is held with its bar arms in a linearly deployable guided manner in a C-profile affixed to the vehicle, and with an advantageous embodiment of the inventive locking device in the form of a blocking bolt arrangement affixed to the vehicle and extending between the bar arms.

FIG. 2 In figure part A shows the retracted rollover protection system of FIG. 1 in a longitudinal section view, in connection with an enlarged segment view of the blocking bolt arrangement in figure part B, likewise in the resting position of the roll bar, and

FIG. 3 shows the rollover protection system in the extended state, i.e. with the roll bar deployed in the supportive, protective position, in two figure parts A, B analogous to FIG. 2.

### DETAILED DESCRIPTION OF THE INVENTION

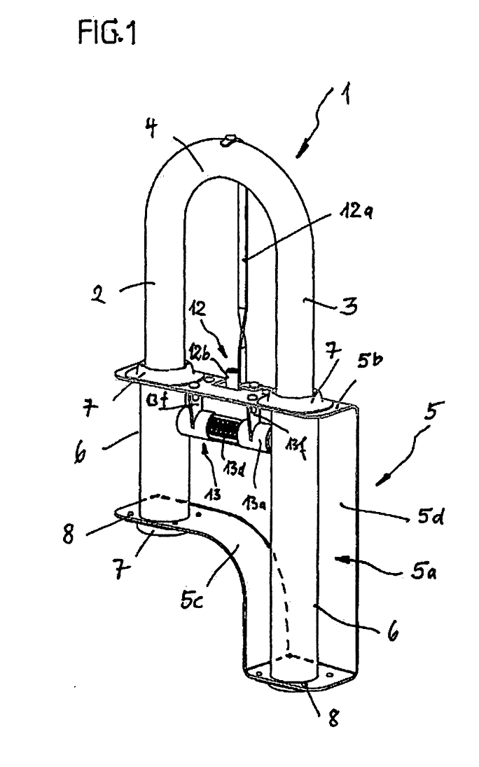

FIG. 1 shows an active rollover protection system for motor vehicles designed in a seat-related manner, which has a U-shaped roll bar 1 as the rollover body, which has two tube shaped bar arms 2, 3 that are connected to one another by means of a bar head 4. Bar arms 2, 3 are held and guided in a holder 5 affixed to the vehicle. For simplicity's sake, only one of the rollover protection systems is shown in FIG. 1. The second system is positioned in the vehicle as a transverse mirror image of the first, and next to the system shown.

Such rollover protection systems are known in a wide variety of embodiments, and therefore do not need to be described in detail here.

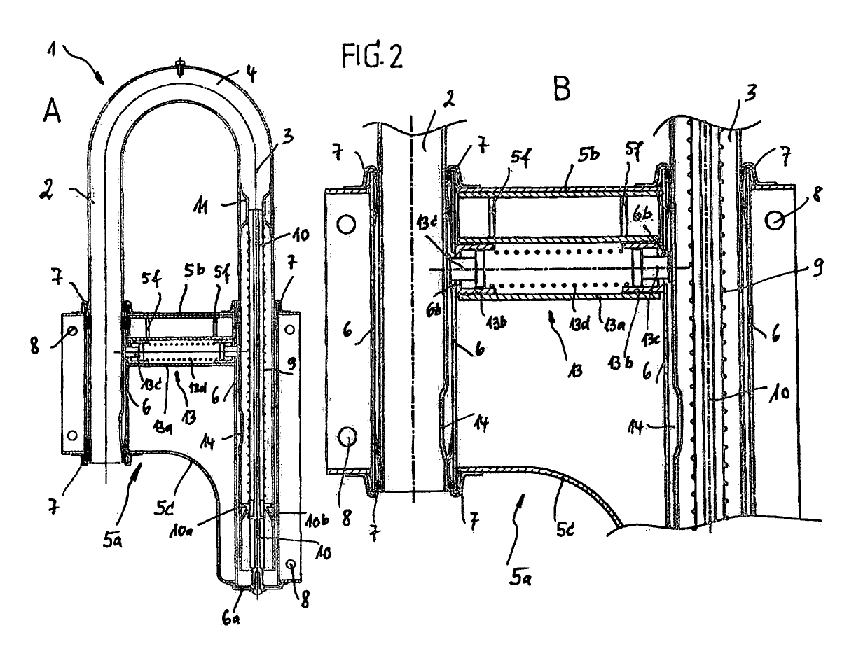

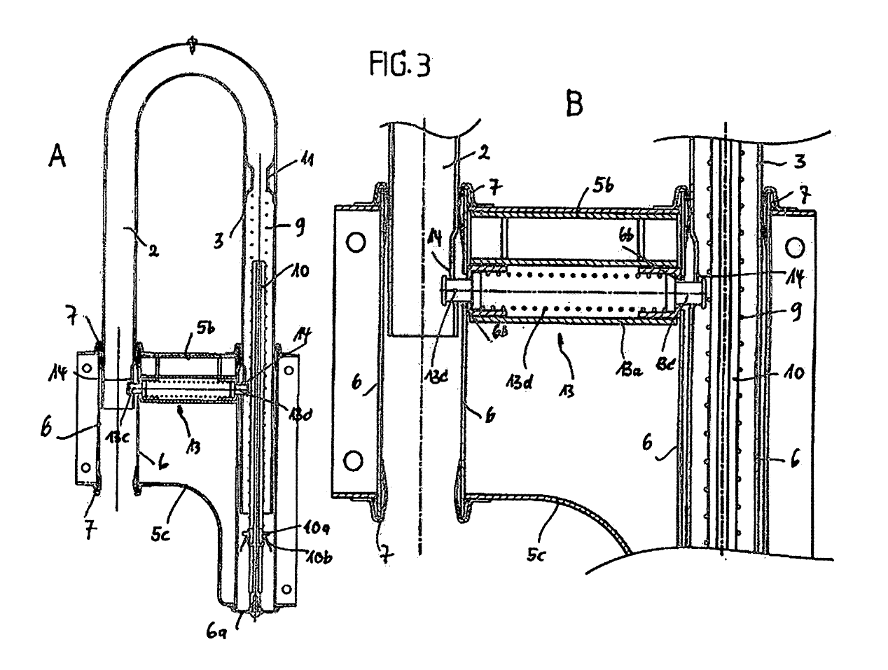

In the example presented, bar arms 2, 3 are designed to be of different lengths, with the rollover protection systems being positioned in the vehicle perpendicular to the driving direction in such a way that the shorter bar arm 2 faces the inside of the vehicle. Holder 5 consists of a sheet-metal molded part in the shape of a C-profile, with an upper, linear arm 5b and a lower, curved arm 5c. Between these two arms, guide tubes 6 are positioned, preferably welded-on, in which bar arms 2, 3 are held, in particular as shown in FIGS. 2 and 3. The guide is supported by guide insets 7, e.g. plastic sockets or flexible sheet metal parts with elastic springlike characteristics, that are inserted into guide tubes 6.

By means of fastening bores 8, C-profile 5a can be connected to the vehicle body or a construction piece connected with the latter. For example, it can be positioned on a cross member at the height of the rear wall that separates the rear passenger compartment of the car from the baggage compartment. Shorter bar arm 2 in connection with curved arm 5c of the C-profile then advantageously frees up space for a loading area. Fastening bores 8 are then located at connection arms 5d of C-profile 5a, as shown in FIGS. 2 and 3.

Roll bar 1 is driven with a helical drive spring 9 that is held in longer bar arm 3. Helical drive spring 9 surrounds a spring guide rod 10, which is fastened on the floor side to a cover 6a. This spring guide rod 10 has a stop 10a with bracing fingers 10b against which the lower end of helical drive spring 9 is braced, in a manner known in the prior art. The upper end of helical drive spring 9 is braced against ring sleeve 11 positioned within bar arm 3, which even in the resting position of the roll bar (FIG. 2 A) holds the tip of spring guide rod 10, in order to hold it in place so that it does not cause whirring sounds or the like in normal driving operation.

In order to hold down roll bar 1 in the resting position against the force of helical drive spring 9 under spring tension, a sensor-controlled holding device 12 with a holding member 12a is provided, that is affixed to roll bar 1 and is connected in a detachable manner to a sensor-controlled activatable actuator arrangement 12b. Only the upper part of this actuator arrangement is visible in FIG. 1.

Such holding devices are known in a wide variety of embodiments, both with pyrotechnic and with electromagnetic actuators, and therefore do not need to be described in detail here.

In order to ensure that deployed roll bar 1 (FIG. 3A) cannot be pressed back into guide tubes 6 of C-profile 5a in a rollover due to the forces arising thereby, actively deployable protection systems have a locking device, the so-called retraction lock. The figures show an advantageous embodiment of a very simple, low-cost locking device 13 according to the invention.

As the locking device, a blocking bolt arrangement 13 is provided in principle between guide tubes 6 of bar arms 2, 3, which extends across the free space between the two guide tubes 6 and is affixed to the vehicle.

The blocking bolt arrangement has a housing 13a that extends perpendicular to the direction of driving. It is firmly attached via fastening segments 13f to the thereby strengthened upper arm 5b of C-profile 5a and is partially cut open in FIG. 1. At both open front faces of housing 13a, as shown in particular in FIGS. 2 and 3, a guide sleeve 13b is firmly attached in each case, in each of which a locking bolt 13c is held in a linearly slidable manner with a collar-like projection. Between the inner ends of locking bolt 13c in housing 13a, a helical pressure spring 13d is held, compressed in the resting state, which places locking bolt 13c under spring tension in the direction of locking.

Each of locking bolts 13c has a head shaped like a mushroom cap for active engagement with locking holes 14.

In order to enable engagement of locking bolts 13c into bar arms 2, 3, guide tube 6 has a penetration opening 6b for penetration of locking bolts 13c.

In the resting position (FIG. 2), the mushroom cap-like heads of locking bolts 13c abut on the closed wall of bar arms 2, 3 under spring tension. In order for the deployment process not to be noticeably impaired, bar arms 2, 3 must be able to slide past the heads of the locking bolts relatively friction-free. The slidability can be achieved in the heads and/or the slide track segments of the bar arms as a function of the material, and by coordinating the spring force of the pressure spring 13d.

In order to enable engagement of locking bolts 13c into bar arms 2, 3 in the deployed, supportive position of roll bar 1 (FIG. 3), internal locking holes 14 are provided in the walls of arm tubes 2, 3.

To ensure that this locking mechanism is able to lock securely, despite the fast extension speed of the rollover body, special measures have been implemented regarding locking holes 14.

Locking holes 14 are designed as oblong holes in the direction of the longitudinal axis of bar arms 2, 3 and the wall areas in which locking holes 14 are located are partially indented, in such a way that an inlet slope results for locking bolts 13c.

The mushroom cap-like structure of the heads of the locking bolts is intended, on the one hand, to facilitate their penetration into locking holes 14 and, on the other hand, to prevent an unwanted retraction of locking bolts 13c.

Due to the form-fitting active engagement of locking bolts 13c with locking holes 14, a stable and secure block against roll bar 1 being pressed back is accomplished.

In the embodiment shown with an extendable U-shaped roll bar, the blocking bolt arrangement is affixed to the vehicle and the corresponding locking openings are designed in the arm tubes of the bar. If the rollover body is designed as a shaped element, then it can have two stops extending vertically lengthwise at a distance, between which the blocking bolt arrangement is affixed to the vehicle. The arrangement was made in such a way that, in each of the two stops positioned at a distance on the shaped element, at least one locking hole is positioned for an active locking engagement with the corresponding locking bolt in the deployed position of the shaped element. In the other positions, the stops, which function virtually as lateral guides, hold the locking bolts back from active engagement against the spring force of the retaining spring.

It is also conceivable to affix the blocking bolt arrangement not to the vehicle, but rather to the rollover body, and to design the locking holes to be in the holder which is fixed to the vehicle. This variant is useful in particular for a cassette system with an inner shaped element as the rollover body, which is guided in an external shaped element affixed to the vehicle, because in these cases typically only very little space is available. However, the blocking bolt arrangement can easily be positioned inside of the rollover body, which has lateral penetration openings for the locking bolts, with the appropriate number of locking holes being designed in the side parts of the external shaped element. In the extended, protective position of the rollover body, of the internal profile, then the locking bolts, also extended, come into active engagement with the corresponding locking hole.

### LIST OF REFERENCE SIGNS

1 Roll bar
2, 3 Bar arms (arm tubes)
4 Bar head
5 Holder affixed to the vehicle
5a C-profile
5b Linear arm
5c Curved arm
5d Connecting arm
6 Guide tubes
6a Cover
6b Penetration holes
7 Guide insets
8 Fastening bores
9 Helical Drive spring
10 Spring guide rod
10a Stop
10b Bracing springs
11 Ring sleeve
12 Holding device
12a Holding member
12b Actuator arrangement
13 Blocking bolt arrangement
13a Housing
13b Guide sleeve
13c Locking bolt
13d Retaining spring (bracing spring)
13f Fastening segments
14 Locking holes

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A rollover protection system for motor vehicles having
a holder affixed to the vehicle,
a rollover body,
a drive for deploying rollover body from a resting position to a protective position,
a device for holding rollover body in the resting position,
a sensor-controlled actuator for triggering holding device and
a blocking bolt arrangement with two locking bolts under spring tension that engage in locking holes of rollover body when rollover body is deployed in the protective position,
wherein the blocking bolt arrangement has a housing affixed to the vehicle and open at an end, in which the locking bolts are positioned at the end with a single pressure spring positioned in between, by means of which the locking bolts can be driven into locking holes.

2. The rollover protection system of claim 1, wherein the rollover body is a U-shaped rollbar in which two parallel bar arms are connected via a bar head, and the blocking bolt arrangement is positioned extending between the bar arms.

3. The rollover protection system of claim 2, wherein the holder, affixed to the vehicle, is formed of a C-profile piece affixed to the vehicle body, which is provided with guide tubes for guiding each of the bar arms between angled arms.

4. The rollover protection system of claim 3, wherein guide insets are positioned in the guide tubes.

5. The rollover protection system of claim 1, wherein the rollover body is designed as a shaped element and the blocking bolt arrangement is positioned between two stops designed to extend lengthwise at a distance on the shaped element.

6. The rollover protection system of claim 1, wherein at each end of the housing a guide sleeve is positioned and the locking bolts are held in a linearly slidable manner via a collar-like projection in the guide sleeves.

7. The rollover protection system of claim 6, wherein heads of the locking bolts are designed with a mushroom-cap shape.

8. The rollover protection systems of claim 1, wherein a locking hole is designed in bar arms of a roll bar or in longitudinally extending stops of a shaped element, for the engagement of the locking bolts.

9. The rollover protection system of claim 8, wherein the locking hole is designed as an oblong hole.

10. The rollover protection system of claim 9, wherein an edge of the locking hole has an inlet slope.

11. The rollover protection system of claim 1, wherein the blocking bolt arrangement is attached to the rollover body and the locking holes are designed in the holder affixed to the vehicle.
